(19) United States
(12) Patent Application Publication
(10) Pub. No.: US 2025/0003182 A1
(43) Pub. Date: Jan. 2, 2025

(54) WORK MACHINE AND CONTROL METHOD FOR WORK MACHINE

(71) Applicant: KOMATSU LTD., Tokyo (JP)

(72) Inventors: Kazumichi OKAJIMA, Tokyo (JP); Yousuke MURAI, Tokyo (JP)

(21) Appl. No.: 18/579,974

(22) PCT Filed: Aug. 9, 2022
(86) PCT No.: PCT/JP2022/030460

§ 371 Date: Jan. 17, 2024

(30) Foreign Application Priority Data
Sep. 30, 2021 (JP) 2021-161321

(51) Int. Cl. E02F 9/08; E02F 9/26

(52) U.S. Cl. CPC E02F 9/0866; E02F 9/26

(57) ABSTRACT

A work machine includes a heat exchange part having at least one heat exchanger, a plurality of cooling fans to cool the heat exchange part, and a controller. The controller changes rotation of the plurality of cooling fans from forward rotation to backward rotation while controlling that when at least one of the cooling fans stops rotating when changing rotation from forward rotation to backward rotation, at least one of the other cooling fans rotates forward or backward.

### CROSS-REFERENCE TO RELATED APPLICATIONS

This application is a U.S. National stage application of International Application No. PCT/JP2022/030460, filed on Aug. 9, 2022. This U.S. National stage application claims priority under 35 U.S.C. § 119(a) to Japanese Patent Application No. 2021-161321, filed in Japan on Sep. 30, 2021, the entire contents of which are hereby incorporated herein by reference.

### BACKGROUND

### Technical Field

The present invention relates to a work machine and a control method for the work machine.

### Background Information

A heat exchanger unit that has a plurality of heat exchangers for cooling various fluids (a refrigerant, etc.) and a cooling fan that supplies cooling air to the heat exchanger unit, are provided to a work machine such as a hydraulic excavator. The heat exchanger unit has disposed therein, for example, a radiator through which passes cooling water for the engine, an oil cooler through which passes hydraulic fluid for operating a hydraulic actuator, and an after-cooler through which passes compressed air (for example, see Japanese Patent Laid-open No. 2020-84520).

Because dust and dirt are often floating free in large amounts at a work site where the work machine is operating, the work machine described in Japanese Patent Laid-open No. 2020-84520 blows away the dust and dirt that becomes carried on and attached to the heat exchanger unit due to the rotation of the cooling fan, by reversing the rotation of the cooling fan.

### SUMMARY

However, when changing the rotation of the cooling fan from forward rotation or backward rotation to clean the heat exchangers, there is a concern that the temperature of the fluid to be cooled such as the refrigerant or compressed air may increase because the rotation of the cooling fan is zero for an instant. As a result, it is difficult to clean the heat exchangers by backward rotation of the cooling fan while the engine is operating.

An object of the present disclosure is to provide a work machine and a method for controlling the work machine with which cleaning of a heat exchanger is possible while suppressing a rise in the temperature of a fluid to be cooled.

A work machine according to a first embodiment of the present disclosure comprises a heat exchange part, a plurality of cooling fans, and a controller. The heat exchange part includes at least one heat exchanger. The plurality of cooling fans cool the heat exchange part. The controller changes rotation of the plurality of cooling fans from forward rotation to backward rotation while controlling that when at least one cooling fan stops rotating when changing rotation from forward rotation to backward rotation, at least one of the other cooling fans rotates forward or backward.

A control method for a work machine according to a second embodiment of the present disclosure, is for a work machine comprising a heat exchange part that includes at least one heat exchanger, and a plurality of cooling fans that cool the heat exchange part, wherein rotation of the plurality of cooling fans is changed from forward rotation to backward rotation while controlling that when at least one cooling fan stops rotating when changing rotation from forward rotation to backward rotation, at least one of the other cooling fans rotates forward or backward.

According to the embodiment of the present disclosure, there can be provided a work machine and a control method for the work machine with which cleaning of a heat exchanger is possible while suppressing a rise in the temperature of a fluid to be cooled.

### BRIEF DESCRIPTION OF THE DRAWINGS

FIG. 1 is a perspective view illustrating a hydraulic excavator according to an embodiment of the present disclosure.

FIG. 2 is a plan view of the hydraulic excavator according to an embodiment of the present disclosure.

FIG. 3 is a perspective view illustrating a rear part of the hydraulic excavator according to an embodiment of the present disclosure.

FIG. 4 is a perspective view of a cooling unit according to the embodiment of the present disclosure seen from a heat exchanger unit side.

FIG. 5 is a perspective view of the cooling unit according to the embodiment of the present disclosure seen from a cooling fan unit side.

FIG. 6 is a front view of the cooling unit according to the embodiment of the present disclosure seen from the left side of the hydraulic excavator.

FIG. 7 is an arrow cross-sectional view along line B-B′ in FIG. 6.

FIG. 8 is a block diagram illustrating a configuration pertaining to a control of the hydraulic excavator according to the embodiment of the present disclosure.

FIG. 9 is a flow chart illustrating a control operation of the hydraulic excavator according to the embodiment of the present disclosure.

### DETAILED DESCRIPTION OF EMBODIMENT(S)

A hydraulic excavator will be described as an example of a work machine according to the present disclosure with reference to the following drawings.

### Configuration

### (Outline of Hydraulic Excavator 1)

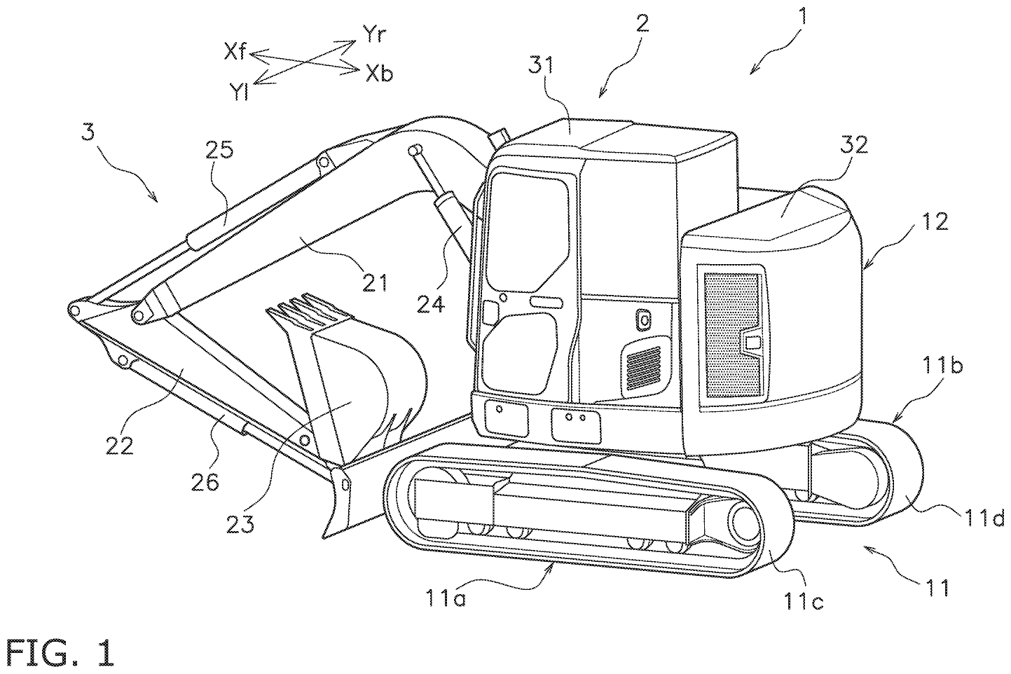

FIG. 1 is a schematic view of a configuration of a hydraulic excavator 1 of the present embodiment.

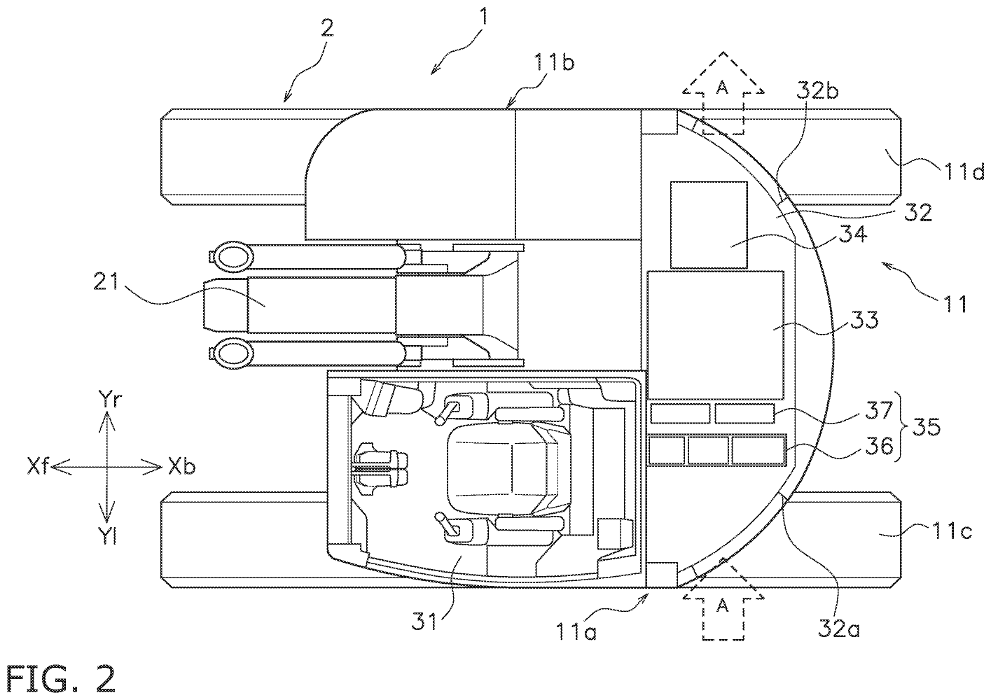

The hydraulic excavator 1 (example of a work machine) includes a vehicle body 2 and a work implement 3. The vehicle body 2 includes a traveling unit 11 and a revolving unit 12 as illustrated in FIG. 1. The traveling unit 11 includes a pair of travel devices 11a and 11b. The travel devices 11a and 11b respectively include crawler belts 11c and 11d. A travel motor rotates due to driving power from an engine 33 (see FIG. 2 below) to drive the crawler belts 11c and 11d whereby the hydraulic excavator 1 travels.

The revolving unit 12 is mounted on the traveling unit 11. The revolving unit 12 is configured to be able to turn with respect to the traveling unit 11 about an axis in the up-down direction by means of an unillustrated revolving device. A cab 31 that contains an operator's seat in which an operator sits during operation, is disposed in a front left side position of the revolving unit 12. The operator's seat, a lever for operating the work implement 3, and various display devices, etc., are disposed inside the cab 31.

In the present embodiment, front and rear and left and right are explained using the driver's seat in the cab 31 as reference in the present embodiment. The direction when the operator's seat faces forward is the forward direction (see arrow Xf) and the direction opposite the forward direction is the rearward direction (see arrow Xb). The right side and left side in the lateral direction when the operator's seat faces forward are respectively the right direction (see arrow Yr) and the left direction (see arrow Yl). The “height direction,” the “vertical direction,” and the “horizontal direction” in the present description indicate, unless specifically stated otherwise, directions while the vehicle body 2 is in a horizontal state without being inclined.

The work implement 3 is attached in a front center position of the revolving unit 12. The work implement 13 includes a boom 21, an arm 22, and an excavating bucket 23 as illustrated in FIG. 1. The base end of the boom 21 is coupled to the revolving unit 12 in a rotatable manner. The tip end of the boom 21 is coupled to the base end of the arm 22 in a rotatable manner. The tip end of the arm 22 is coupled to the excavating bucket 23 in a rotatable manner. The excavating bucket 23 is attached to the arm 22 so that the opening thereof faces in the direction (rearward) of the revolving unit 12. The hydraulic excavator 1 including the excavating bucket 23 attached in this manner is also referred to as a backhoe.

Hydraulic cylinders 24-26 (boom cylinder 24, arm cylinder 25, and bucket cylinder 26) are disposed so as to respectively correspond to the boom 21, the arm 22, and the excavating bucket 23. The work implement 3 is driven due to the driving of the cylinders 24-26. As a result, work such as excavation can be carried out.

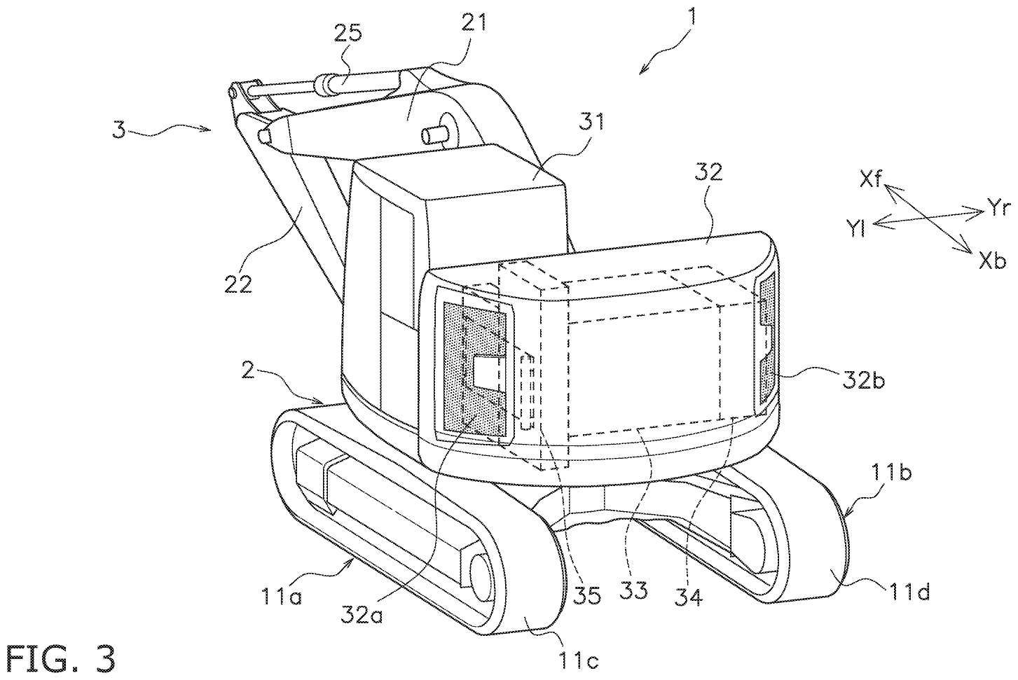

An engine room 32 is disposed on the rear side of the cab 31 on the revolving unit 12. FIG. 2 is a plan view of the hydraulic excavator 1 illustrating the internal configuration of the engine room 32. FIG. 3 is a perspective view of the hydraulic excavator 1 seen from the rear. The revolving unit 12 further includes the engine 33, a hydraulic pump 34, and a cooling unit 35. The engine room 32 is disposed on the rear part side of the cab 31.

As illustrated in FIGS. 2 and 3, the engine room 32 contains the engine 33, the hydraulic pump 34, and the cooling unit 35. The cooling unit 35, the engine 33, and the hydraulic pump 34 are disposed side by side in order from the left side to the right side. The engine 33 generates driving power. The engine 33 is an internal combustion engine such as a diesel engine. The hydraulic pump 34 is connected to the engine 33. The hydraulic pump 34 is driven by the engine 33 and discharges hydraulic fluid. The hydraulic fluid discharged from the hydraulic pump 34 is supplied to the abovementioned hydraulic cylinders 24-26.

The cooling unit 35 cools various fluids to be cooled such as a refrigerant or compressed air. An air intake port 32a is disposed in a side wall of the engine room 32 on the left side of the cooling unit 35. A net is disposed on the air intake port 32a. An air discharge port 32b is disposed in a side wall of the engine room 32 on the right side of the hydraulic pump 34. A net is disposed on the air discharge port 32b. The cooling unit 35 includes a plurality of cooling fans 51a, 51b, and 51c (discussed below). When the cooling fans 51a, 51b, and 51c rotate in the forward direction, outside air is drawn into the engine room 32 from the air intake port 32a as indicated by arrow A in FIG. 2. The air drawn into the engine room 32 passes in order over the engine 33 and the hydraulic pump 34 and is discharged to the outside through the air discharge port 32b.

### (Cooling Unit 35)

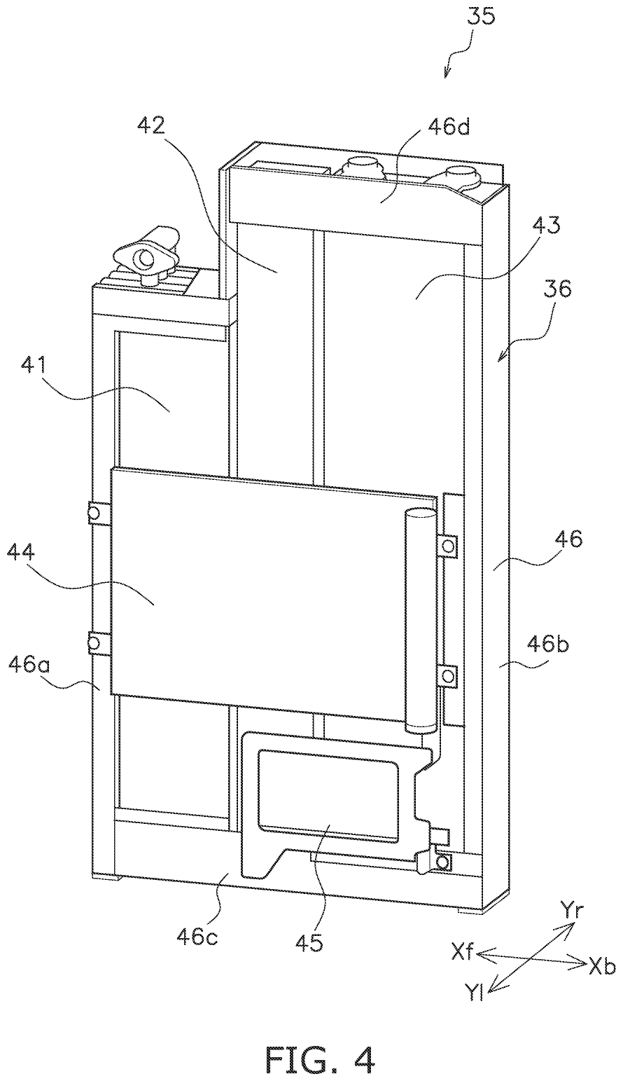

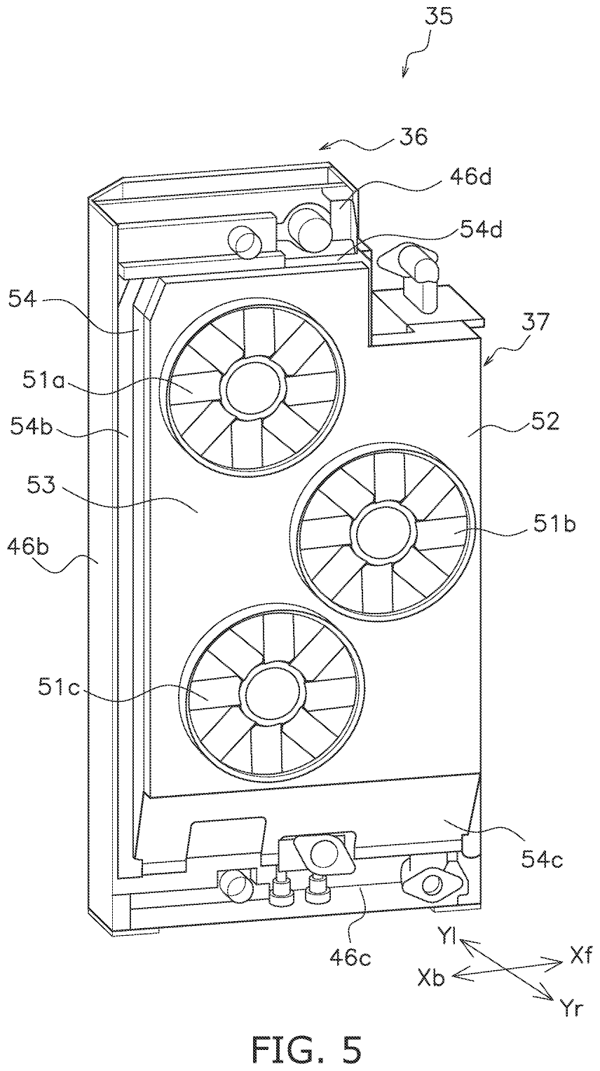

FIG. 4 is a perspective view of the cooling unit 35. FIG. 4 is a perspective view of the cooling unit 35 seen from the left side of the hydraulic excavator 1. FIG. 5 is a perspective view of the cooling unit 35. FIG. 5 is a perspective view of the cooling unit 35 seen from the right side of the hydraulic excavator 1.

As illustrated in FIGS. 2 and 5, the cooling unit 35 includes a heat exchanger unit 36 (example of a heat exchange part) and a cooling fan unit 37. The heat exchanger unit 36 includes a plurality of heat exchangers (discussed below) that cool the fluids to be cooled. The cooling unit 35 supplies cooling air to the heat exchanger unit 36.

The heat exchanger unit 36 is disposed on the left side of the cooling unit 35. The heat exchanger unit 36 is disposed on the air intake port 32a side of the cooling unit 35. The heat exchanger unit 36, the cooling fan unit 37, the engine 33, and the hydraulic pump 34 are disposed in order from the air intake port 32a to the air discharge port 32b.

### (Heat Exchanger Unit 36)

As illustrated in FIG. 4, the heat exchanger unit 36 includes an oil cooler 41, an after-cooler 42, a radiator 43, an air-conditioner condenser 44, and a fuel cooler 45. The oil cooler 41, the after-cooler 42, the radiator 43, the air-conditioner condenser 44, and the fuel cooler 45 are each examples of heat exchangers.

Hydraulic fluid for operating hydraulic actuators such as the hydraulic cylinders 24-26 is supplied to the oil cooler 41. The hydraulic fluid is cooled while passing through the oil cooler 41. The oil cooler 41 is disposed in a front part of the heat exchanger unit 36. A seen in the left-right direction of the hydraulic excavator 1, the oil cooler 41 has a rectangular shape that is longer in the up-down direction.

Compressed air that is outdoor air drawn in and compressed by an unillustrated supercharger, is supplied to the after-cooler 42. The after-cooler 42 is connected to the engine 33. The compressed air is cooled while passing through the after-cooler 42 and is supplied to the engine 33. The after-cooler 42 is disposed on the rear side of the oil cooler 41. A seen in the left-right direction of the hydraulic excavator 1, the after-cooler 42 has a rectangular shape that is longer in the up-down direction. The after-cooler 42 is formed to be higher than the oil cooler 41.

Cooling water for the engine 33 is supplied to the radiator 43. The supplied cooling water is cooled while passing through the radiator 43 and is discharged toward the engine 33. The radiator 43 is disposed on the rear side of the after-cooler 42. A seen in the left-right direction of the hydraulic excavator 1, the radiator 43 has a rectangular shape that is longer in the up-down direction. The radiator 43 is formed to have roughly the same height as the after-cooler 42.

The oil cooler 41, the after-cooler 42, and the radiator 43 are disposed side by side in order from the front side of the hydraulic excavator 1 to the rear side.

A refrigerant for an air conditioner to be used for air-conditioning the cab 31 is supplied to the air-conditioner condenser 44. The supplied refrigerant is cooled while passing through the air-conditioner condenser 44 and is discharged toward the air conditioner. The air-conditioner condenser 44 is disposed on the left side of the oil cooler 41, the after-cooler 42, and the radiator 43. The air-conditioner condenser 44 is disposed on the air intake port 32a side of the oil cooler 41, the after-cooler 42, and the radiator 43. The air-conditioner condenser 44 is disposed roughly in the center in the up-down direction of the oil cooler 41, the after-cooler 42, and the radiator 43. The air-conditioner condenser 44 is disposed across the oil cooler 41, the after-cooler 42, and the radiator 43 in the front-back direction.

Fuel for the engine 33 is supplied to the fuel cooler 45. The fuel is cooled while passing through the fuel cooler 45 and is supplied to the engine 33. The fuel cooler 45 is disposed on the left side of the after-cooler 42 and the radiator 43. The fuel cooler 45 is disposed on the air intake port 32a side of the after-cooler 42 and the radiator 43. The fuel cooler 45 is disposed across the after-cooler 42 and the radiator 43. The fuel cooler 45 is disposed below the air-conditioner condenser 44.

A frame 46 supports the oil cooler 41, the after-cooler 42, and the radiator 43. The frame 46 is disposed so as to surround the circumferential edge portions of the oil cooler 41, the after-cooler 42, and the radiator 43 disposed side by side. The air-conditioner condenser 44 is fixed to a front portion 46a of the frame 46 disposed at the front edge part of the oil cooler 41, and a rear portion 46b of the frame 46 disposed at the rear edge part of the radiator 43. The fuel cooler 45 is fixed to the rear portion 46b of the frame 46 and a lower portion 46c of the frame 46 disposed at a lower edge part of the oil cooler 41, the after-cooler 42, and the radiator 43.

At least one of the hydraulic fluid supplied to the oil cooler 41, the compressed air supplied to the after-cooler 42, the cooling water supplied to the radiator 43, the refrigerant supplied to the air-conditioner condenser 44, and the fuel supplied to the fuel cooler 45, corresponds to an example of the fluid to be cooled.

### (Cooling Fan Unit 37)

As illustrated in FIG. 5, the cooling fan unit 37 includes the plurality of cooling fans 51a, 51b, and 51c, and a shroud 52. The plurality of cooling fans 51a, 51b, and 51c are rotatably supported in the shroud 52.

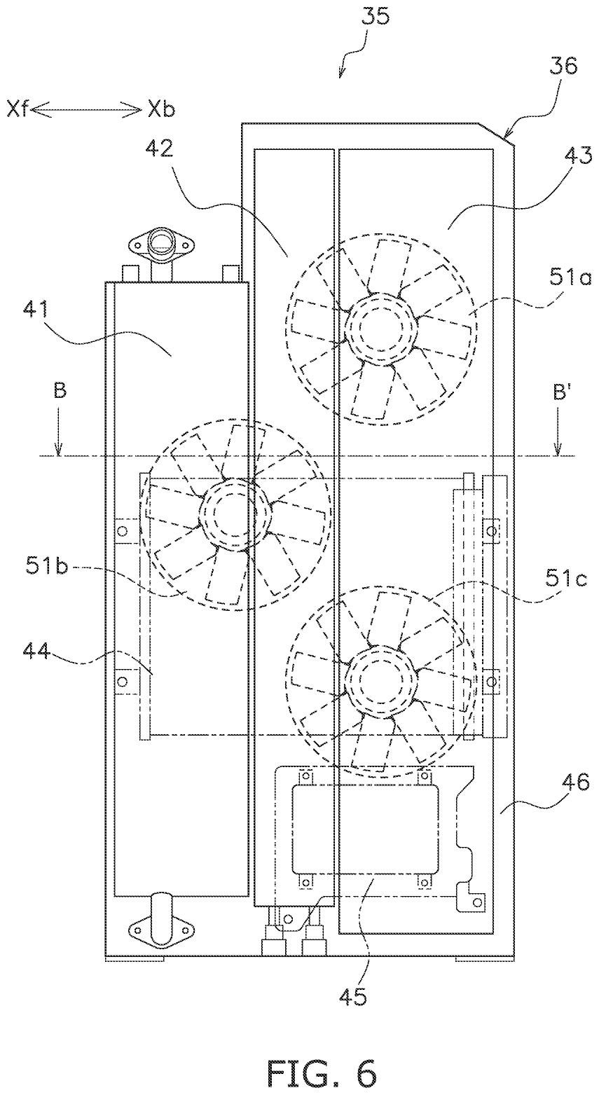

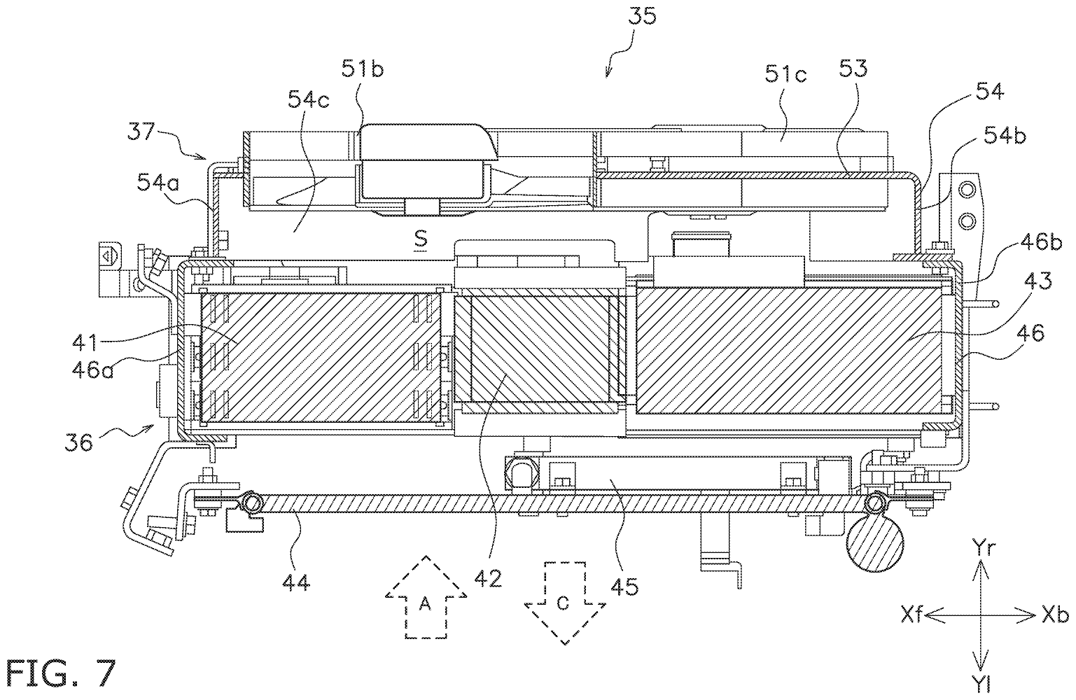

FIG. 6 is a perspective view of the cooling unit 35 seen from the left side of the hydraulic excavator 1 (along the suction direction of air). FIG. 7 is an arrow cross-sectional view along line B-B′ in FIG. 6. In FIG. 6, in order to illustrate the positional relationships between the oil cooler 41, the after-cooler 42, the radiator 43, and the cooling fans 51a, 51b, and 51c, the air-conditioner condenser 44 and the fuel cooler 45 are depicted with chain double-dashed lines and the rear of the air-conditioner condenser 44 and the fuel cooler 45 is depicted with solid lines.

The cooling fans 51a, 51b, and 51c are electric fans. The cooling fans 51a, 51b, and 51c are disposed on the right side of the heat exchanger unit 36. The cooling fans 51a, 51b, and 51c are disposed facing the oil cooler 41, the after-cooler 42, and the radiator 43 with a predetermined interval therebetween.

The shroud 52 is attached to the frame 46. The shroud 52 includes a facing surface 53 and a side surface part 54. The facing surface 53 is disposed facing the oil cooler 41, the after-cooler 42, and the radiator 43 with a predetermined interval therebetween. The cooling fans 51a, 51b, and 51c are disposed on the facing surface 53. The side surface part 54 is connected between the circumferential edge of the facing surface 53 and the circumferential edge parts of the oil cooler 41, the after-cooler 42, and the radiator 43. The side surface part 54 is fixed to the frame 46 provided at the circumferential edge parts of the oil cooler 41, the after-cooler 42, and the radiator 43. The side surface part 54 covers the front side, the rear side, the upper side, and the lower side of a space S (see FIG. 7) formed between the facing surface 53 and the oil cooler 41, the after-cooler 42, and the radiator 43. As illustrated in FIG. 7, a front portion 54a formed from the front end of the facing surface 53 toward the heat exchanger unit 36 within the side surface part 54, is fixed to the front portion 46a of the frame 46. Also, a rear portion 54b formed from the rear end of the facing surface 53 toward the heat exchanger unit 36 within the side surface part 54, is fixed to the rear portion 46b of the frame 46. As illustrated in FIG. 5, a lower portion 54c formed from the lower end of the facing surface 53 toward the heat exchanger unit 36 within the side surface part 54, is fixed to a lower portion 46c of the frame 46, and an upper portion 54d formed from the upper end of the facing surface 53 toward the heat exchanger unit 36 within the side surface part 54, is fixed to an upper portion 46d of the frame 46. In this way, the space between the facing surface 53 where the cooling fans 51a, 51b, and 51c are disposed and the heat exchanger unit 36 is surrounded by the side surface part 54, and the cooling air caused by the rotation of the cooling fans 51a, 51b, and 51c is efficiently supplied to the heat exchanger unit 36.

As illustrated in FIG. 6, the cooling fans 51a, 51b, and 51c are disposed in order from the upper direction downward. The cooling fan 51a is disposed facing the after-cooler 42 and the radiator 43. The cooling fan 51b is disposed facing the oil cooler 41 and the after-cooler 42. The cooling fan 51c is disposed facing the after-cooler 42 and the radiator 43. The cooling fan having the largest surface area overlapping the after-cooler 42 is the cooling fan 51b among the cooling fans 51a, 51b, and 51c. The surface areas overlapping the after-cooler 42 of the cooling fan 51a and the cooling fan 51c are roughly the same.

When the cooling fans 51a, 51b, and 51c rotate in the forward direction, outside air is suctioned through the air intake port 32a and is supplied to the inside of the engine room 32 as indicated by arrow A in FIG. 2. The air suctioned in from the air intake port 32a passes through the heat exchanger unit 36, cools the fluid to be cooled in each of the heat exchangers, passes through the engine 33 and the hydraulic pump 34, and is discharged from the engine room 32 through the air discharge port 32b.

Due to the forward rotation of the cooling fans 51a, 51b, and 51c in this manner, surrounding dirt and dust adheres to a mesh of the air intake port 32a and dirt and dust that passes through the air intake port 32a adheres to the heat exchanger unit 36. In order to blow away the dirt and dust adhered to the air intake port 32a and the heat exchanger unit 36, a backward rotation control is performed to rotate the cooling fans 51a, 51b, and 51c backward. By rotating the cooling fans 51a, 51b, and 51c backward, cleaning of the air intake port 32a and the heat exchanger unit 36 is performed. In FIG. 7, the direction that the air flows during backward rotation is indicated by the arrow C.

### (Control Configuration of Hydraulic Excavator 1)

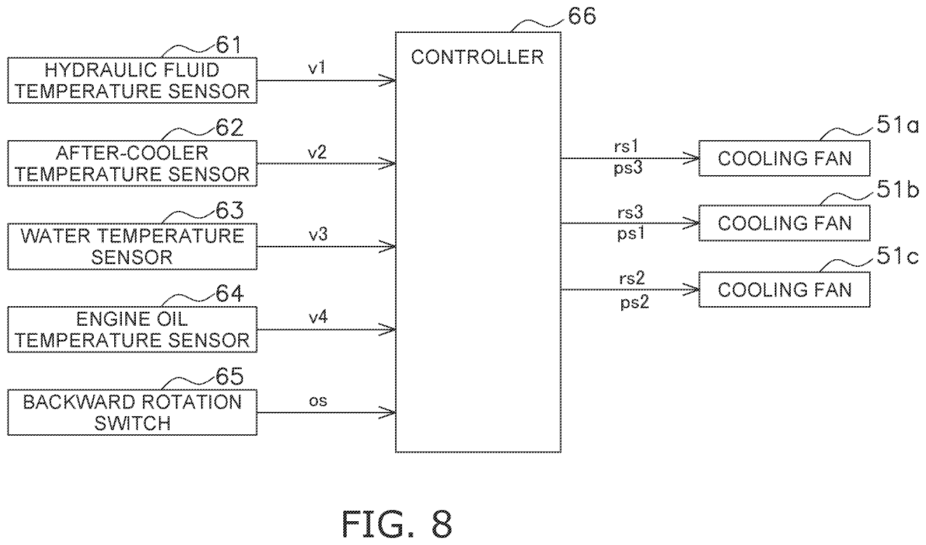

A configuration related to the control of the hydraulic excavator 1 of the present embodiment is discussed below. FIG. 8 is a block diagram for explaining a configuration pertaining to the control of the hydraulic excavator 1.

The hydraulic excavator 1 further includes a hydraulic fluid temperature sensor 61, an after-cooler temperature sensor 62, a water temperature sensor 63, an engine oil temperature sensor 64, a backward rotation switch 65, and a controller 66.

The hydraulic fluid temperature sensor 61 detects the temperature of the hydraulic fluid passing through the oil cooler 41 and transmits a detection value v1 to the controller 66. The hydraulic fluid temperature sensor 61 detects the temperature of the hydraulic fluid at the inlet of the oil cooler 41. Without being limited thereto, the hydraulic fluid temperature sensor 61 may also detect the temperature of the hydraulic fluid at the outlet of the oil cooler 41 or may further detect the temperature of the hydraulic fluid at both the inlet and the outlet of the oil cooler 41.

The after-cooler temperature sensor 62 detects the temperature of the air passing through the after-cooler 42 and transmits a detection value v2 to the controller 66. The after-cooler temperature sensor 62 detects the temperature of the air at the outlet of the after-cooler 42. Without being limited thereto, the after-cooler temperature sensor 62 may also detect the temperature of the air at the inlet of the after-cooler 42 or may also detect the temperature of the air at the inlet and the outlet of the after-cooler 42.

The water temperature sensor 63 detects the temperature of the cooling water passing through the radiator 43 and transmits a detection value v3 to the controller 66. The water temperature sensor 63 detects the temperature of the cooling water at the inlet of the radiator 43. Without being limited thereto, the water temperature sensor 63 may also detect the temperature of the cooling water at the outlet of the radiator 43 or may also detect the temperature of the cooling water at the inlet and the outlet of the radiator 43.

The engine oil temperature sensor 64 is disposed in an oil pan of the engine 33. The engine oil temperature sensor 64 detects the temperature of the engine oil and transmits a detection value v4 to the controller 66.

The backward rotation switch 65 is disposed inside the cab 31. The backward rotation switch 65 may be displayed, for example, on a touch panel or may be a button-type switch. The backward rotation switch 65 is operated by the driver to cause the cooling fans 51a, 51b, and 51c to rotate backward to clean the air intake port 32a and the heat exchanger unit 36. When the driver operates the backward rotation switch 65, an operation signal os is transmitted to the controller 66.

The controller 66 includes a processor and a storage device. The processor is, for example, a central processing unit (CPU). Alternatively, the processor may be a processor different from a CPU. When the processor receives the operation signal os, the processor executes the backward rotation control for changing the rotation of the cooling fans 51a, 51b, and 51c from forward rotation to backward rotation on the basis of the detection values v1 to v4 in accordance with a program.

The storage device includes a non-volatile memory such as a read-only memory (ROM) and/or a volatile memory such as a random access memory (RAM). The storage device may also include an auxiliary storage device such as a hard disk or a solid state drive (SSD). The storage device is an example of a non-transitory computer-readable recording medium. The storage device stores a first threshold, a second threshold, a third threshold, and a fourth threshold for determining whether to carry out the backward rotation control. The first threshold is set for the detection value v1 of the hydraulic fluid temperature sensor 61. The second threshold is set for the detection value v2 of the after-cooler temperature sensor 62. The third threshold is set for the detection value v3 of the water temperature sensor 63. The fourth threshold is set for the detection value v4 of the engine oil temperature sensor 64. At least one of the first threshold, the second threshold, the third threshold, and the fourth threshold corresponds to an example of a predetermined value.

When the controller 66 receives the operation signal os by means of to the operation of the backward rotation switch 65, the controller 66 determines whether the cooling fans 51a, 51b, and 51c are allowed to rotate backward on the basis of the temperatures of the fluids to be cooled.

The controller 66 compares the detection values and the thresholds set for the detection values and executes the backward rotation control when all of the detection values are equal to or below the thresholds. Specifically, the controller 66 executes the backward rotation control when the detection value v1 of the hydraulic fluid temperature sensor 61 is equal to or less than the first threshold, the detection value v2 of the after-cooler temperature sensor 62 is equal to or less than the second threshold, the detection value v3 of the water temperature sensor 63 is equal to or less than the third threshold, and the detection value v4 of the engine oil temperature sensor 64 is equal to or less than the fourth threshold.

The first threshold, the second threshold, the third threshold, and the fourth threshold are set in consideration of a rise in temperature due to the backward rotation of the cooling fans 51a, 51b, and 51c. Because the wind amount when the cooling fans are rotating backward is less than the wind amount when rotating forward, the temperatures of the fluids to be cooled that pass through the heat exchanger unit 36 rise more during backward rotation in comparison to during forward rotation. The first threshold, the second threshold, the third threshold, and the fourth threshold are set to temperatures at which the engine 33 is able to drive normally even when the temperatures increase caused by changing from forward rotation to backward rotation is added to the respective thresholds.

When the controller 66 receives the operation signal os and determines that backward rotation of the cooling fans 51a, 51b, and 51c is allowed, the controller 66 changes the cooling fans from forward rotation to backward rotation in order of the cooling fan 51a, the cooling fan 51c, and the cooling fan 51b.

Specifically, the controller 66 transmits a backward rotation instruction signal rs1 to the cooling fan 51a, and after a first predetermined time period has elapsed, transmits a backward rotation instruction signal rs2 to the cooling fan 51c, and after a second predetermined time period has elapsed, transmits a backward rotation instruction signal rs3 to the cooling fan 51b. The first predetermined time period is set to a period from the transmission of the backward rotation instruction signal rs1 to the cooling fan 51a until the cooling fan 51a stably rotates backward at a constant rotation speed. The second predetermined time period is set to a period from the transmission of the backward rotation instruction signal rs2 to the cooling fan 51c until the cooling fan 51c stably rotates backward at a constant rotation speed. The first predetermined time period and the second predetermined time period may be set to the same time period or to different time periods.

When a third predetermined time period from the transmission of the backward rotation instruction signal rs3 to the cooling fan 51b has elapsed, the controller 66 changes the backward rotation back to the forward rotation in order of the cooling fan 51b, the cooling fan 51c, and the cooling fan 51a. The third predetermined time period is set to at least a period from the transmission of the backward rotation instruction signal rs3 to the cooling fan 51b until the cooling fan 51b stably rotates backward at a constant rotation speed. The time period during which all of the cooling fans 51a, 51b, and 51c are rotating backward can be adjusted by changing the third predetermined time period. For example, the time period during which all of the cooling fans 51a, 51b, and 51c are rotating backward can be increased by increasing the third predetermined time period. The backward rotation instruction signals rs1, rs2, and rs3 each correspond to an example of a control signal.

When changing the rotation of the cooling fans 51a, 51b, and 51c from the backward rotation back to the forward rotation, the controller 66 transmits a forward rotation instruction signal ps1 to the cooling fan 51b and, after a fourth predetermined time period has elapsed, transmits a forward rotation instruction signal ps2 to the cooling fan 51c. The controller 66 then transmits a forward rotation instruction signal ps3 to the cooling fan 51a after transmitting the forward rotation instruction signal ps2 and a fifth predetermined time period has elapsed.

The fourth predetermined time period is set to a period from the transmission of the forward rotation instruction signal ps1 to the cooling fan 51a until the cooling fan 51a rotates from backward rotation to stable forward rotation at a constant rotation speed. The fifth predetermined time period is set to a period from the transmission of the forward rotation instruction signal ps2 to the cooling fan 51c until the cooling fan 51c rotates from backward rotation to stable forward rotation at a constant rotation speed.

As indicated above, the cooling fan 51b having the largest surface area facing the after-cooler 42 is changed from the forward rotation to the backward rotation at the latest timing among the plurality of cooling fans 51a, 51b, and 51c. Because the after-cooler 42 cools the compressed air obtained by taking in and compressing the outdoor air, the temperature of the compressed air is more likely to rise due to the stoppage of the cooling fans 51a, 51b, and 51c in comparison to the refrigerant that constitutes the closed circuits such as the radiator 43 or the oil cooler 41. As a result, cleaning can be performed by means of the backward rotation of the cooling fans 51a, 51b, and 51c even during the driving of the engine 33, by suppressing the rise in temperature of the air passing through the after-cooler 42.

Accordingly, in the present embodiment, a rise in temperature of the compressed air passing through the after-cooler 42 can be suppressed by causing the cooling fan 51a that blows the greatest wind amount to the after-cooler 42 to rotate forward last among the other cooling fans 51a and 51c.

In addition, because a large wind amount can be blown toward the after-cooler 42 at an earlier timing by returning the cooling fan 51b to the forward rotation first when returning the rotation of the cooling fans 51a, 51b, and 51c from forward rotation to backward rotation, a rise on the temperature of the compressed air passing through the after-cooler 42 is suppressed even more.

### Operation

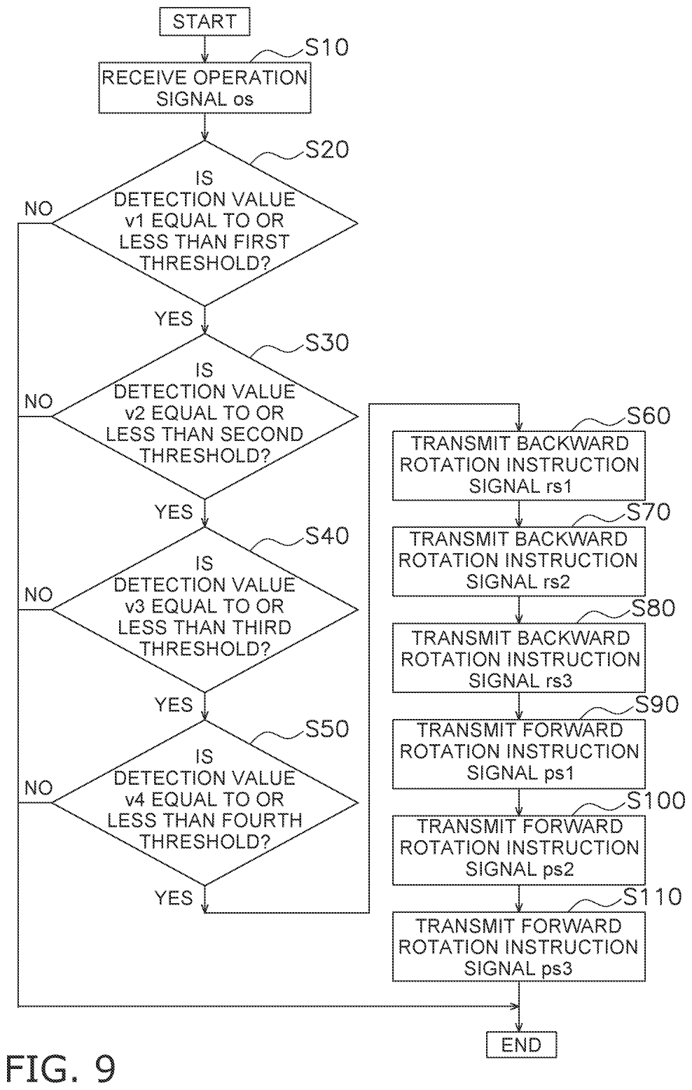

The operation of the backward rotation control of the hydraulic excavator 1 according to the present embodiment will be discussed below. FIG. 9 is a flow chart illustrating operations of the backward rotation control of the hydraulic excavator 1 according to the present embodiment.

In step S10, the controller 66 receives the operation signal os transmitted by the backward rotation switch 65 when the driver operates the backward rotation switch 65.

Next in step S20, the controller 66 determines whether the detection value v1 of the hydraulic fluid temperature sensor 61 is equal to or less than the first threshold. When it is determined that the detection value v1 is not equal to or less than the first threshold in step S20, the control is finished. When it is determined that the detection value v1 is equal to or less than the first threshold in step S20, the control advances to step S30.

In step S30, the controller 66 determines whether the detection value v2 of the after-cooler temperature sensor 62 is equal to or less than the second threshold. When it is determined that the detection value v2 is not equal to or less than the second threshold in step S30, the control is finished. When it is determined that the detection value v2 is equal to or less than the second threshold in step S30, the control advances to step S40.

In step S40, the controller 66 determines whether the detection value v3 of the water temperature sensor 63 is equal to or less than the third threshold. When it is determined that the detection value v3 is not equal to or less than the third threshold in step S40, the control is finished. When it is determined that the detection value v3 is equal to or less than the third threshold in step S40, the control advances to step S50.

In step S50, the controller 66 determines whether the detection value v4 of the engine oil temperature sensor 64 is equal to or less than the fourth threshold. When it is determined that the detection value v4 is not equal to or less than the fourth threshold in step S50, the control is finished. When it is determined that the detection value v4 is equal to or less than the fourth threshold in step S50, the control advances to step S60.

In step S60, the controller 66 transmits the backward rotation instruction signal rs1 to the cooling fan 51a. The cooling fan 51a receives the backward rotation instruction signal rs1 and changes the rotating direction from forward rotation to backward rotation.

After the first predetermined time period has elapsed after the transmission of the backward rotation instruction signal rs1, in step S70, the controller 66 transmits the backward rotation instruction signal rs2 to the cooling fan 51c. The cooling fan 51c receives the backward rotation instruction signal rs2 and changes the rotating direction from forward rotation to backward rotation.

After the second predetermined time period has elapsed after the transmission of the backward rotation instruction signal rs2, in step S80, the controller 66 transmits the backward rotation instruction signal rs3 to the cooling fan 51b. The cooling fan 51b receives the backward rotation instruction signal rs3 and changes the rotating direction from forward rotation to backward rotation.

After the third predetermined time period has elapsed after the transmission of the backward rotation instruction signal rs3, in step S90, the controller 66 transmits the forward rotation instruction signal ps1 to the cooling fan 51b. The cooling fan 51b receives the forward rotation instruction signal ps1 and changes the rotating direction from backward rotation to forward rotation.

After the fourth predetermined time period has elapsed after the transmission of the forward rotation instruction signal ps1, in step S100, the controller 66 transmits the forward rotation instruction signal ps2 to the cooling fan 51c. The cooling fan 51c receives the forward rotation instruction signal ps2 and changes the rotating direction from backward rotation to forward rotation.

After the fifth predetermined time period has elapsed after the transmission of the forward rotation instruction signal ps2, in step S110, the controller 66 transmits the forward rotation instruction signal ps3 to the cooling fan 51c and the control is finished. The cooling fan 51a receives the forward rotation instruction signal ps3 and changes the rotating direction from backward rotation to forward rotation.

As described above, cleaning of the heat exchanger unit 36 can be performed and adhered dust and dirt can be blown away by changing the rotation of the cooling fans 51a, 51b, and 51c from forward rotation to backward rotation.

### (Characteristics)

(1)

The hydraulic excavator 1 (example of a work machine) of the present embodiment comprises the heat exchanger unit 36 (example of a heat exchange part), the plurality of cooling fans 51a, 51b, and 51c, and the controller 66. The heat exchanger unit 36 includes at least one heat exchanger. The plurality of cooling fans 51a, 51b, 51c cool the heat exchanger unit 36. The controller 66 changes the rotation of the plurality of cooling fans 51a, 51b, and 51c from forward rotation to backward rotation while controlling that when at least one cooling fan stops rotating when changing the rotation from forward rotation to backward rotation, at least one of the other cooling fans rotates forward or backward.

In this way, the controller 66 changes the rotation of all of the plurality of cooling fans 51a, 51b, and 51c from forward rotation to backward rotation while controlling that when at least one of the cooling fans 51a, 51b, and 51c stops rotating when changing the rotation from forward rotation to backward rotation, at least one of the other cooling fans rotates forward or backward.

As a result, the rotation is changed from the forward rotation to the backward rotation without stopping all of the cooling fans 51a, 51b, and 51c at the same time, whereby a rise in the temperature of the fluid to be cooled of the heat exchanger unit 36 is suppressed. As a result, cleaning of the heat exchangers can be performed while suppressing a rise in the temperature of the fluid to be cooled. In addition, because the rise in temperature of the fluid to be cooled can be suppressed, the cleaning of the heat exchangers can be performed even while the engine 33 is operating.

(2)

The cooling fans 51a, 51b, and 51c in the hydraulic excavator 1 of the present embodiment are electric fans.

By using electric fans in this way, the rotating direction can be easily changed from forward rotation to backward rotation. In addition, electric fans are relatively small and a plurality of fans can be arranged. As a result, the occurrence of a timing when cooling air is stopped can be avoided by controlling the plurality of electric fans when performing the cleaning of the heat exchangers.

(3)

In the hydraulic excavator 1 of the present embodiment, the controller 66 transmits the backward rotation instruction signal rs1 for changing rotation from forward rotation to backward rotation to at least one cooling fan 51a, and thereafter, after the first predetermined time period (example of a predetermined time period) has elapsed, the controller 66 transmits the backward rotation instruction signal rs2 for changing rotation from forward rotation to backward rotation to at least one other cooling fan 51c. Moreover, the controller 66 transmits the backward rotation instruction signal rs2 for changing rotation from forward rotation to backward rotation to at least one cooling fan 51c, and thereafter, after the second predetermined time period (example of a predetermined time period) has elapsed, the controller 66 transmits the backward rotation instruction signal rs3 for changing rotation from forward rotation to backward rotation to at least one other cooling fan 51b.

For example, the first predetermined time period can be set to a time period from when the cooling fan 51a rotates forward until the cooling fan 51a stably rotates backward at a constant rotation speed. For example, the second predetermined time period can be set to a time period from when the cooling fan 51c rotates forward until the cooling fan 51c stably rotates backward at a constant rotation speed.

As a result, because the stopping timing of the other cooling fans occurs after the predetermined cooling fan has started rotating backward and the number of rotations has stabilized, the occurrence of a timing at which all of the cooling fans are stopped at the same time can be avoided.

(4)

In the hydraulic excavator 1 of the present embodiment, the controller 66 changes the rotation of the cooling fans 51a, 51b, and 51c from forward rotation to backward rotation one by one in order.

As a result, all of the cooling fans 51a, 51b, and 51c can be changed from forward rotation to backward rotation one by one in order.

(5)

The hydraulic excavator 1 of the present embodiment further includes the hydraulic fluid temperature sensor 61, the after-cooler temperature sensor 62, the water temperature sensor 63, and the engine oil temperature sensor 64. The hydraulic fluid temperature sensor 61 detects the temperature of the fluid to be cooled subjected to heat exchange in the oil cooler 41. The after-cooler temperature sensor 62 detects the temperature of the fluid to be cooled subjected to heat exchange in the after-cooler 42. The water temperature sensor 63 detects the temperature of the fluid to be cooled subjected to heat exchange in the radiator 43. The controller 66 changes the rotation of the plurality of cooling fans 51a, 51b, and 51c from forward rotation to backward rotation when the detection value v1 of the hydraulic fluid temperature sensor 61 is equal to or less than the first threshold, the detection value v2 of the after-cooler temperature sensor 62 is equal to or less than the second threshold, the detection value v3 of the water temperature sensor 63 is equal to or less than the third threshold, and the detection value v4 of the engine oil temperature sensor 64 is equal to or less than the fourth threshold.

The wind amount of the cooling air is less when all of the cooling fans 51a, 51b, and 51c are rotating backward than when all of the cooling fans 51a, 51b, and 51c are rotating forward. As a result, the temperatures of the fluids to be cooled rise. By setting the respective thresholds to temperatures that take the temperature rise amount into account, the control for changing from the forward rotation to the backward rotation can be performed after having determined whether the temperatures of the fluids to be cooled in the heat exchanger unit 36 are in a state in which backward rotation is allowed.

(6)

In the hydraulic excavator 1 of the present embodiment, the heat exchanger unit 36 includes the after-cooler 42 as a heat exchanger.

Because the after-cooler 42 cools the compressed air obtained by taking in and compressing the outdoor air, the temperature of the compressed air is more likely to rise due to the stoppage of the cooling fans 51a, 51b, and 51c in comparison to a fluid to be cooled that constitutes a closed circuit such as the radiator 43 or the oil cooler 41. In the hydraulic excavator 1 of the present embodiment, because a timing at which all of the cooling fans are stopped at the same time can be avoided when changing the rotation of the cooling fans 51a, 51b, and 51c from forward rotation to backward rotation, a rise in temperature of the compressed air passing through the after-cooler 42 can be suppressed. As a result, the cleaning of the after-cooler 42 can be performed even while the engine 33 is operating.

(7)

In the hydraulic excavator 1 of the present embodiment, the heat exchanger unit 36 includes the radiator 43 and the oil cooler 41 as the plurality of heat exchangers.

As a result, cleaning can also be performed on the radiator 43 and the oil cooler 41 while suppressing a rise in temperature of the fluids to be cooled.

(8)

In the hydraulic excavator 1 of the present embodiment, the controller 66 changes the rotation of the cooling fan 51b that has the largest surface area overlapping the after-cooler 42 when seen in the suction direction of the air, from the forward rotation to the backward rotation last among the plurality of cooling fans 51a, 51b, and 51c.

Because the temperature of the fluid to be cooled in the after-cooler 42 is more likely to rise than that in the radiator 43 or the oil cooler 41, a rise in the temperature of the after-cooler 42 can be suppressed by causing the cooling fan 51b that blows the most wind toward the after-cooler 42 to rotate backward last.

(9)

The hydraulic excavator 1 of the present embodiment further comprises the backward rotation switch 65. The backward rotation switch 65 is operated by the driver and transmits the operation signal os to the controller 66. When the controller 66 receives the operation signal os, the controller 66 changes the rotation of the plurality of cooling fans 51a, 51b, and 51c from forward rotation to backward rotation.

As a result, the heat exchanger unit 36 can be cleaned at a timing desired by the driver.

(10)

The control method for the hydraulic excavator of the present embodiment, is a control method for a hydraulic excavator comprising the heat exchanger unit 36 that includes at least one heat exchanger, and the plurality of cooling fans 51a, 51b, and 51c that cool the heat exchanger unit 36, wherein, the rotation of the plurality of cooling fans 51a, 51b, and 51c is changed from forward rotation to backward rotation while controlling that when at least one cooling fan stops rotating when changing the rotation from forward rotation to backward rotation, at least one of the other cooling fans rotates forward or backward.

In this way, the rotation of all of the plurality of cooling fans 51a, 51b, and 51c is changed from forward rotation to backward rotation while controlling that when at least one of the cooling fans stops rotating when changing the rotation from forward rotation to backward rotation, at least one of the other cooling fans rotates forward or backward.

As a result, the rotation can be changed from the forward rotation to the backward rotation without stopping all of the cooling fans 51a, 51b, and 51c at the same time, whereby a rise in the temperature of a fluid to be cooled of the heat exchanger unit 36 is suppressed. As a result, cleaning of the heat exchangers can be performed while suppressing a rise in the temperature of the fluids to be cooled. In addition, because the rise in the temperature of the fluids to be cooled can be suppressed, the cleaning of the heat exchangers can be performed even while the engine 33 is operating.

### (Other Embodiments)

Although an embodiment of the present invention has been described so far, the present invention is not limited to the above embodiment and various modifications may be made within the scope of the invention.

### (A)

While the rotation of the cooling fan 51a, the cooling fan 51c, and the cooling fan 51b are changed from forward rotation to backward rotation one by one in order in the hydraulic excavator 1 of the above embodiment, the present invention is not limited in this way. For example, the rotation of two of the cooling fans may be changed from forward rotation to backward rotation at the same time, and then the rotation of the one remaining cooling fan may be changed from forward rotation to backward rotation. Specifically, for example, the rotation of the cooling fan 51a and the cooling fan 51c are changed from forward rotation to backward rotation at the same time by transmitting the backward rotation instruction signals to the cooling fan 51a and the cooling fan 51c at the same time. After the backward rotation of the cooling fans 51a and 51c has become stable at a constant number of rotations, the rotation of the cooling fan 51b is changed from forward rotation to backward rotation by transmitting the backward rotation instruction signal to the cooling fan 51b.

Moreover, the rotation of one of the cooling fans may be changed from forward rotation to backward rotation, and then the rotation of the two remaining cooling fans may be changed from forward rotation to backward rotation at the same time. Specifically, for example, the rotation of the cooling fan 51a is changed from forward rotation to backward rotation by transmitting the backward rotation instruction signal to the cooling fan 51a. After the backward rotation of the cooling fan 51a has become stable at a constant number of rotations, the rotation of the cooling fan 51b and the cooling fan 51c is changed from forward rotation to backward rotation at the same time by transmitting the backward rotation instruction signals to the cooling fan 51b and the cooling fan 51c at the same time.

### (B)

While three cooling fans 51a, 51b, and 51c are disposed in the hydraulic excavator 1 of the above embodiment, the number is not limited to three and two or four or more cooling fans may be provided.

When four or more cooling fans are provided, the plurality of cooling fans may be divided into a plurality of groups and the rotation thereof may be changed from forward rotation to backward rotation in order in units of groups. The number of cooling fans included in each of the plurality of groups may be the same or may be different. Additionally, a plurality of cooling fans may not necessarily be included in each group, and only one cooling fan may be included in a group.

### (C)

While the rotation of the cooling fan 51a is changed to backward rotation before the cooling fan 51c in the hydraulic excavator 1 of the above embodiment, because the surface areas of the cooling fan 51a and the cooling fan 51c overlapping the after-cooler 42 are roughly the same, either of the cooling fans may be changed to backward rotation first. In addition, the rotation of either of the cooling fan 51a and the cooling fan 51c may be changed back first when changing the rotation back to the forward rotation.

### (D)

While the backward rotation control is performed for changing the rotation of the plurality of cooling fans 51a, 51b, and 51c from forward rotation to backward rotation when the detection value v1 of the hydraulic fluid temperature sensor 61 is equal to or less than the first threshold, the detection value v2 of the after-cooler temperature sensor 62 is equal to or less than the second threshold, the detection value v3 of the water temperature sensor 63 is equal to or less than the third threshold, and the detection value v4 of the engine oil temperature sensor 64 is equal to or less than the fourth threshold in the hydraulic excavator 1 of the above embodiment, the present invention is not limited in this way. For example, the determination of the detection value v4 of the engine oil temperature sensor 64 being equal to or less than the fourth threshold may not be performed. In addition, while not all of the determinations of whether the abovementioned detection values are equal to or less than the thresholds may be performed, it is desirable that the determination of whether the detection value v2 of the after-cooler temperature sensor 62 is equal to or less than the second threshold is performed. Because the after-cooler 42 cools the compressed air obtained by taking in and compressing the outside air, the rise in temperature due to stopping the cooling fans 51a, 51b, and 51c is noticeable. As a result, it desirable that the temperature of the compressed air that is the fluid to be cooled of the after-cooler 42 is detected and the determination of whether the temperature is equal to or greater than the threshold is performed.

### (E)

While the observation of the rise in temperature using the detection value of the hydraulic fluid temperature sensor 61, the detection value of the after-cooler temperature sensor 62, the detection value of the water temperature sensor 63, and the detection value of the engine oil temperature sensor 64 is not performed while the cooling fans 51a, 51b, and 51c are rotating backward in the hydraulic excavator 1 of the above embodiment, the observation of said rise in temperature may also be performed.

For example, a fifth threshold may be set with respect to the detection value v1 of the hydraulic fluid temperature sensor 61, a sixth threshold may be set with respect to the detection value v2 of the after-cooler temperature sensor 62, a seventh threshold may be set with respect to the detection value v3 of the water temperature sensor 63, and an eighth threshold may be set with respect to the detection value v4 of the engine oil temperature sensor 64.

Even during steps S60 to S80, when the detection value of the hydraulic fluid temperature sensor 61 is equal to or greater than the fifth threshold, the detection value of the after-cooler temperature sensor 62 is equal to or greater than the sixth threshold, the detection value of the water temperature sensor 63 is equal to or greater than the seventh threshold, or the detection value of the engine oil temperature sensor 64 is equal to or greater than the eighth threshold, the controller 66 may change the rotation of the cooling fans 51a, 51b, and 51c back to forward rotation.

### (F)

In the above embodiment, the controller 66 performs the control of changing the rotation of the cooling fans 51a, 51b, and 51c to backward rotation after having determined the temperatures when receiving the operation signal transmitted by the driver operating the backward rotation switch 65. Therefore the operation of the backward rotation switch 65 is used as the trigger for the control but the present invention is not limited in this way. For example, a timer may be provided in the controller 66 or separately, and the controller 66 may determine whether the detection values v1 to v4 are equal to or less than the respective thresholds at each predetermined time period, and when the detection values v1 to v4 are equal to or less than the thresholds, the backward rotation control may be performed.

### (G)

While the rotation of the cooling fans 51a, 51b, and 51c is changed back to the forward rotation after changing from the forward rotation to the backward rotation in the hydraulic excavator 1 of the above embodiment, the present invention is not limited thereto. For example, the rotation of the cooling fans 51a, 51b, and 51c may be stopped without rotating forward when the engine 33 is stopped after causing the cooling fans 51a, 51b, and 51c to rotate backward.

### (H)

While a hydraulic excavator was used as an example of the work machine in the above embodiment, the present invention is not limited in this way and the work machine may be a bulldozer, a wheel loader, a dump truck, a forklift, etc.

According to the present disclosure, cleaning of heat exchangers can be performed effectively while suppressing a rise in temperature of a fluid to be cooled, and the present disclosure is useful in a work machine, etc.

1. A work machine comprising:
a heat exchange part including at least one heat exchanger;
a plurality of cooling fans configured to cool the heat exchange part; and
a controller configured to change rotation of the plurality of cooling fans from forward rotation to backward rotation while controlling that when at least one of the cooling fans stops rotating when changing rotation from forward rotation to backward rotation, at least one of the other cooling fans rotates forward or backward.

2. The work machine according to claim 1, wherein
the cooling fans are electric fans.

3. The work machine according to claim 1, wherein
the controller is configured to
transmit a control signal in order to change rotation from forward rotation to backward rotation to at least one of the cooling fans and thereafter,
after a predetermined time period has elapsed, transmit a control signal in order to change rotation from forward rotation to backward rotation to at least one of the other cooling fans.

4. The work machine according to claim 3, wherein
the controller is configured to change the rotation of the plurality of cooling fans from forward rotation to backward rotation one by one in order.

5. The work machine according to claim 1, further comprising:
a temperature sensor configured to detect a temperature of a fluid to be cooled by being subjected to heat exchange in the heat exchanger,
the controller being configured to change the rotation of the plurality of cooling fans from forward rotation to backward rotation when a value detected by the temperature sensor is equal to or less than a predetermined value.

6. The work machine according to claim 1, wherein
the heat exchange part includes an after-cooler as the heat exchanger.

7. The work machine according to claim 6, wherein
the heat exchange part further includes a radiator and an oil cooler as a plurality of heat exchangers.

8. The work machine according to claim 6, wherein
the controller is configured to change the rotation of the cooling fan having a largest surface area overlapping the after-cooler as viewed along a suction direction of air, from the forward rotation to the backward rotation last among the plurality of cooling fans.

9. The work machine according to claim 1, further comprising:
a backward rotation switch operated by a driver, the backward rotation switch being configured to transmit an operation signal to the controller,
the controller being configured to change the rotation of the plurality of cooling fans from forward rotation to backward rotation upon receiving the operation signal.

10. A control method of a work machine including a heat exchange part including at least one heat exchanger, and a plurality of cooling fans configured to cool the heat exchange part, the method comprising:
changing rotation of the plurality of the cooling fans from forward rotation to backward rotation while controlling that when at least one of the cooling fans stops rotating when changing rotation from forward rotation to backward rotation, at least one of the other cooling fans rotates forward or backward.
